(19) United States
(12) Patent Application Publication
(10) Pub. No.: US 2010/0070648 A1
(43) Pub. Date: Mar. 18, 2010

(54) TRAFFIC GENERATOR AND METHOD FOR TESTING THE PERFORMANCE OF A GRAPHIC PROCESSING UNIT

(76) Inventors: Chunlei ZHU, Shanghai (CN); Yu Bai, Shanghai (CN); Zhengwei Jiang, Shanghai (CN); Ko Yu, Shanghai (CN); Karol Menezes, Portland, OR (US); Craig M. Wittenbrink, Palo Alto, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/326,050

(22) Filed: Dec. 1, 2008

(30) Foreign Application Priority Data
Sep. 18, 2008 (CN) 200810211887.3

(51) Int. Cl. G06F 15/173

(52) U.S. Cl. 709/235

(57) ABSTRACT

The present invention relates to a traffic generator and a method for testing the performance of the memory system of graphic processing unit. The traffic generator comprises: at least one simulated engine module, each for generating at least one read stream and/or at least one write stream; and an output arbiter for selecting a stream to be output from a group comprising the at least one read stream and/or the at least one write stream; wherein the selected stream is arranged to be output to the memory system of graphic processing unit.

### CROSS-REFERENCE TO RELATED APPLICATIONS

This application claims benefit of Chinese patent application number 200810211887.3, filed Sep. 18, 2008, which is herein incorporated by reference.

### FIELD OF THE INVENTION

The present invention relates to traffic generator. More particularly, the present invention relates to traffic generator for testing the performance of a graphic processing unit.

### DESCRIPTION OF THE PRIOR ART

A graphics processing unit (GPU) is a dedicated graphics rendering device for a personal computer, workstation, or game console. Modern GPUs are very efficient at manipulating and displaying computer graphics, and their highly parallel structure makes them more effective than general-purpose CPUs for a range of complex algorithms. Generally, a GPU can sit on top of a video card, or it can be integrated directly into the motherboard.

When testing the performance of a GPU, a traffic generator and a traffic monitor are arranged. The traffic generator produces data to be processed by the GPU, and then the traffic monitor observes the traffic, so as to evaluate the performances of the GPU. Since the modern GPU is required to processing image data of different formats, the test for GPU becomes more complex.

In the technical field of high performance GPU, a traffic generator is in great demand for simulating multiple engines (“clients”) which send a series of requests for reading and writing. Therefore, it is necessary to test the efficiency of memory system of the GPU under multiple clients to see whether the design can meet the performance requirement. For example, the engines in the HD Video Decode flows include: SEC, VLD, MSPDEC, MSPPP, Display, and Graphics. However, at the very beginning of the design phase, it is hard to have so many real clients be implemented. As a result, a traffic generator capable of emulating plural of different engines is required.

### SUMMARY OF THE INVENTION

The present invention provides a general traffic generator capable of emulating plural of changeable engines to test the performance of a graphic processing unit. The present invention also provides a simpler method for emulating plural changeable engines with a single device to test the performance of a graphic processing unit.

According to an embodiment of the present invention, the traffic generator for testing the performance of a graphic processing unit comprises: at least one simulated engine module for generating at least one read stream and/or at least one write stream, and an output arbiter for selecting a stream to be output from a group comprising the at least one read stream and/or the at least one write stream; wherein the selected stream is arranged to be output to the memory system of the graphic processing unit.

According to another embodiment of the present invention, the method for testing the performance of a graphic processing unit comprises: setting a configuration of at least one simulated engine module and an output arbiter; generating at least one read stream and/or at least one write stream by the at least one simulated engine module; selecting a stream to be output from a group comprising the at least one read stream and/or the at least one write stream by the output arbiter; outputting the selected stream to the memory system of the graphic processing unit.

The traffic generator and method for testing the performance of a graphic processing unit of the present invention is capable of simulating traffics of many changeable clients without creating these clients actually one by one. By modifying the configurations controlled by the configuration module, the traffic generator of the present invention becomes a more flexible instrument for testing the performance of graphic processing units under different environments.

To make the aforementioned and other objects, features, and advantages of the present invention more comprehensible, preferred embodiments accompanied with figures are described in detail below.

### BRIEF DESCRIPTION OF THE DRAWING

FIG. 1 shows a block diagram of a traffic generator 100 of a preferred embodiment of the present invention.

FIG. 2 shows a surface which is divided by 256 (16×16) byte macroblocks.

### DETAILED DESCRIPTION OF THE INVENTION

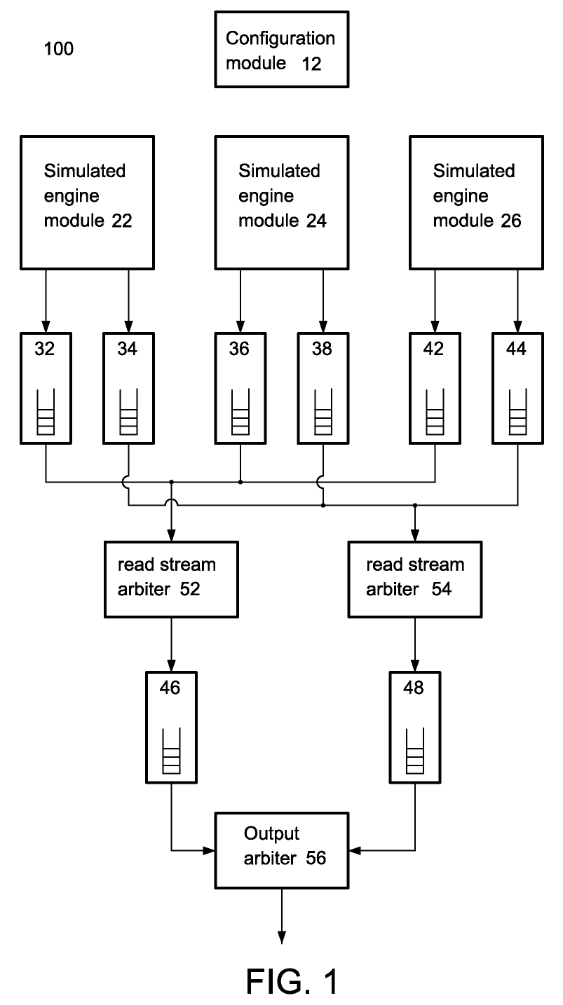

Referring to FIG. 1, the traffic generator 100 includes a configuration module 12, plural of simulated engine modules 22, 24 and 26, read buffers 32, 36, 42 and 46, write buffers 34, 38, 44 and 48, read stream arbiter 52, write stream arbiter 54 and output arbiter 56. The preferred embodiment of the method for testing the performance of a graphic processing unit in the present invention is also disclosed as follows. The simulated engine modules 22, 24 and 26 simulate plural of engines (or “clients”), wherein each engine generates a read stream and/or a write stream. The generated read streams are respectively pushed in to the read buffers 32, 36 and 42 temporally, and the generated write streams are respectively pushed into the write buffers 34, 38 and 44 temporally. All the read buffers 32, 36 and 42 are electrically connected to the read stream arbiter 52, which selects one of the read streams stored in read buffers 32, 36 and 42 each time in the round robin manner or randomly and then output the selected read stream to the read buffer 46. When the round robin manner is adapted, the streams stored in different buffer are selected in turn. For example, if the read arbiter 52 adapts the round robin manner, it selects and outputs the read streams from read buffer 32, read buffer 36, read buffer 42 sequentially and then goes back to the read buffer 32 again. If the read arbiter 52 adapts the random manner, the read stream selected cannot be predicted. Similarly, all the write buffers 34, 38 and 44 are electrically connected to the write stream arbiter 54, which selects one of the write streams stored in write buffers 34, 38 and 44 each time in the round robin manner or randomly and then output the selected write stream to the write buffer 48. The selecting manner adapted by the read arbiter 52 and the write arbiter 48 depends on the configurations set by the configuration module 12. The read stream output from the read arbiter 52 is stored in the read buffer 46 temporally, and the write stream output from the write arbiter 54 is stored in the write buffer 48 temporally. The output arbiter 56 then select one of the read stream and the write stream and output the same to the graphic processing unit under test. In the same manner, the selecting manner adapted by the output arbiter 56 depends on the configurations set by the configuration module 12.

According to the preferred embodiment of the present invention, the configuration module 12 is capable of determining the characteristic of the traffic generator, such as the number and type of the engines simulated. That is to say, the number of the simulated engine modules is not limited to three in the present invention.

Furthermore, the configuration module 12 is capable of defining the characteristics of each generated stream, such as throughput and access pattern. As a result, the engines simulated by the traffic generator may have different behaviors. For example, the configuration module 12 may define the address and size of each read or write request. If the start address 0x1000 is determined, the configuration module 12 may further define the access patterns, such as sequential or random. As to sequential pattern, the address is increased with equal intervals. For example, if the request size is 32B, the sequential addresses to be accessed should be 0x1000, 0x1020, 0x1040, 0x1060 . . . . The sequential pattern can be used to simulate display traffic with pitch surface. For random pattern, each address is generated randomly, with the scope of each surface, e.g., 0x1300, 0x2200, 9x1800 . . . . The random pattern can be used to simulate motion compensation stream in MSPDEC engine. For some other stream, there can be many other complex access patterns. Like in video engines, we have one access pattern called “semi sequential.”

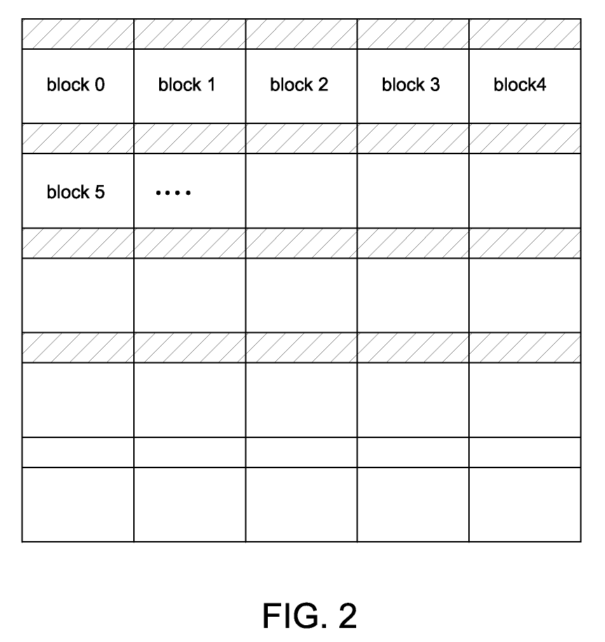

As illustrated in FIG. 2, the surface is divided by 256 (16×16) byte macroblocks. For a picture with a width of N macroblocks (in FIG. 2, N=5), the first 64 bytes of blocks are written in sequential, then the second 64 bytes of blocks 0 . . . N-1 are written in sequential, and etc. Please note that the configuration module 12 of the present invention can adapt any access pattern if necessary, so as to simulate the relative engines. Nevertheless, since there exists many kinds of access patterns, we will not describe every access pattern in the specification.

Besides access patterns, the configuration module 12 is capable of defining the throughput of each stream, which would be determined when to send the request. Take display client for example, for worst case, each line will have 2048 pixels, each pixel is in 4 byte, and the monitor should scan one line every 7.28 μsecs. So we get the throughput:

$$\frac{2048 \times 4}{7.28 \times 1000} = 1.13 GB \text{/} s$$

If we want to test whether high throughput traffic will stress out our graphic processing unit, the throughput would be increased. Please note that since each client will be composed of several read or write streams, each stream may have different access pattern and throughput parameters in the configuration module 12.

According to a preferred embodiment of the present invention, the configuration module comprises a knobfile for recording the above-mentioned characteristics and parameters of the data stream. When the designer of the graphic processing unit would like to test the graphic processing unit, the designer can simulate different kinds of plural engines with the traffic generator by editing the knobfile, so as to test the graphic processing unit under a predetermined environment. If the designer would like to test the graphic processing unit under another environment (with different clients), the knobfile is modified.

A knobfile is used for simulating a copy engine, which is a client copying data from source surface to destination surface, as an example. The knobfile contains the following contents for a read stream:

FermiPerfSim::COPYENGINE::readStreamNum 1
FermiPerfSim::COPYENGINE::readStreamName0 srcSurface
FermiPerfSim::COPYENGINE::srcSurface::start_virt_address 0x10000
FermiPerfSim::COPYENGINE::srcSurface::surface_size_x 1600
FermiPerfSim::COPYENGINE::srcSurface::surface_size_y 1080
#pitch, block, 16×16 MacroBlock
FermiPerfSim::COPYENGINE::srcSurface::surface_type 0
FermiPerfSim::COPYENGINE::srcSurface::burst_size0 32
#throughput, MBytesPerSec
FermiPerfSim::COPYENGINE::srcSurface::throughput 200
#access pattern, seq, ran, semi_seq...,seq for srcSurface
FermiPerfSim::COPYENGINE::srcSurface::acc_pattern 0

In the above content described in the knobfile, the first two lines define the read stream number and read stream name, the next five lines define the start address, surface size and surface type, and the next five lines define the burst size, throughput and access pattern. In the same manner, the write stream for the copy engine can be define as follows:

FermiPerfSim::numTGs 1
FermiPerfSim::HubImpl::clientName0 COPYENGINE
FermiPerfSim::COPYENGINE::readStreamNum 1
# source surfacere
FermiPerfSim::COPYENGINE::readStreamName0 srcSurface
FermiPerfSim::COPYENGINE::srcSurface::start_virt_address 0x10000
FermiPerfSim::COPYENGINE::srcSurface::surface_size_x 1600
FermiPerfSim::COPYENGINE::srcSurface::surface_size_y 1080
#pitch, block, 16×16 MacroBlock
FermiPerfSim::COPYENGINE::srcSurface::surface_type 0
FermiPerfSim::COPYENGINE::srcSurface::burst_size0 32
#throughput, MBytesPerSec
FermiPerfSim::COPYENGINE::srcSurface::throughput 200
#access pattern, seq, ran, semi_seq...,seq for srcSurface
FermiPerfSim::COPYENGINE::srcSurface::acc_pattern 0

After reading above content described in the knobfile, the configuration module 12 enable the traffic generator 100 to act as a copy engine. In the preferred embodiment of the present invention, the knobfile is an external configuration file. Therefore, the user can easily modify the content of the knobfile, so as to simulate different engines with the traffic generator. In summary, to create different engines with a traffic generator, a user must define how many engines and how many streams the traffic generator has and what characteristics each steam is. Such definition of the traffic generator may be obtained by analyzing the behaviors of clients or the results from previous generation chips. Therefore, the traffic generator cannot only simulate the clients already have, but those under implementing. When the user would like to create a new client, just add relative content into the knobfile which describes the stream characteristics of such client.

Given the above, the advantage of the present invention is to simulate traffics of many clients without creating these clients actually one by one. By editing the knobfile or configurations stored in the configuration module, the traffic generator of the present invention can simulate different engines, and thus becomes a more flexible instrument for testing the performance of graphic processing units.

It will be apparent to those skilled in the art that various modifications and variations can be made to the structure of the present invention without departing from the scope or spirit of the invention. In view of the foregoing, it is intended that the present invention cover modifications and variations of this invention, provided that they fall within the scope of the following claims and their equivalents.

We claim:

1. A traffic generator for testing the performance of a memory system of graphic processing unit, comprising:
at least one simulated engine module for generating at least one read stream and/or at least one write stream; and
an output arbiter for selecting a stream from the at least one read stream and the at least one write stream;
wherein the selected stream is output to the graphic processing unit.

2. A traffic generator of claim 1, further comprising:
at least one first read buffer, electrically connected between the at least one simulated engine module and the read stream arbiter, each first read buffer buffering one read stream and transferring the buffered read stream to the read stream arbiter.

3. A traffic generator of claim 2, further comprising:
at least one first write buffer, electrically connected between the at least one simulated engine module and the write stream arbiter, each first write buffer buffering a write stream and transferring the buffered write stream to the write stream arbiter.

4. A traffic generator of claim 3,further comprising:
a read stream arbiter, electrically connected between the at least one first read buffer and the output arbiter, for selecting a read stream from the at least one read stream and transferring the selected read stream to the output arbiter.

5. A traffic generator of claim 4, further comprising:
a write stream arbiter, electrically connected between the at least one first write buffer and the output arbiter, for selecting a write stream from a the at least one write stream and transferring the selected write stream to the output arbiter.

6. A traffic generator of claim 5, further comprising:
a second read buffer, electrically connected between the read stream arbiter and the output arbiter, for buffering the selected read stream and transferring the same to the output arbiter; and
a second write buffer, electrically connected between the write stream arbiter and the output arbiter, for buffering the selected write stream and transferring the same to the output arbiter.

7. A traffic generator of claim 1, further comprising:
a configuration module for controlling configurations of the at least one simulated engine module, and controlling the characteristics of the read streams and/or write streams generated by the simulated engine modules.

8. A traffic generator of claim 7, wherein the configurations relate to data throughput of each simulated engine module, packet size of a read and/or write stream generated by each simulated engine module and access pattern.

9. A traffic generator of claim 7, wherein the configurations further relates to the selecting manners of the output arbiter, the read stream arbiter and the write stream arbiter.

10. A traffic generator of claim 7, wherein the configuration module controls the configurations according to the content of an external configuration file.

11. A method for testing the performance of a graphic processing unit, comprising:
setting configurations of at least one simulated engine module and an output arbiter;
generating at least one read stream and/or at least one write stream by the at least one simulated engine module;
selecting a stream to be output from a group comprising the at least one read stream and/or the at least one write stream by the output arbiter;
outputting the selected stream to the graphic processing unit.

12. A method of claim 11, further comprising:
after each read stream is generated, buffering each read stream, respectively.

13. A method of claim 12, further comprising:
after each write stream is generated at least one second write buffer, buffering each write stream, respectively.

14. A method of claim 13, further comprising:
after buffering the least one read stream, selecting a read stream from the at least one read stream.

15. A method of claim 14, further comprising:
after buffering the least one write stream, selecting a write stream from the at least one write stream.

16. A method of claim 15, further comprising:
buffering the selected read stream and transferring the same to the output arbiter.

17. A method of claim 16, further comprising:
buffering the selected write stream and transferring the same to the output arbiter.

18. A method of claim 11, wherein the configurations of the at least one simulated engine module are arranged to change the characteristics of the read streams and/or write streams generated by the at least one simulated engine module.

19. A method of claim 18, wherein the configuration relates to data throughput of each simulated engine module, packet size of read or write stream generated by each simulated engine module and access pattern.

20. A method of claim 18, wherein the configuration further relates to selecting manners for selecting the read streams and/or write streams.
